(19) United States
(12) Patent Application Publication
(10) Pub. No.: US 2009/0019041 A1
(43) Pub. Date: Jan. 15, 2009

(54) Filename Parser and Identifier of Alternative Sources for File

(76) Inventor: Marc Colando, Seattle, WA (US)

Correspondence Address: NEWMAN & NEWMAN, ATTORNEYS AT LAW, LLP, 505 FIFTH AVENUE SOUTH, SUITE 610, SEATTLE, WA, 98104, US

(21) Appl. No.: 11/776,439

(22) Filed: Jul. 11, 2007

(51) Int. Cl. G06F 17/30

(52) U.S. Cl. 707/6; 707/5; 707/E17.061

(57) ABSTRACT

The filename for an unknown work, corresponding file contents, and information associated with the filename are parsed and analyzed and compared to information relating to one or more known works, which known works comprise at least broadcast television shows and other audio visual works. Information regarding the known works may be presented to at least one user, confirmation may be obtained, and alternative sources may be presented, from which alternative sources the known works may be obtained.

### BACKGROUND

Private, semi-private, and governmental organizations have developed industry trade numbers and codes, hereinafter referred to as “identifiers,” to uniquely identify books, audiovisual works, musical recordings, recordings, and product in a wide range of contexts. For example, the International Standard Book Number or “ISBN” is a unique commercial book identifier; the International Standard Serial Number is used to identify a print or electronic periodical publication; the Amazon Standard Identification Number (“ASIN”) is a product identifier used by Amazon.com, Inc.; the International Standard Audiovisual Number (“ISAN”) is a unique identifier for audiovisual works and related versions; the Compact Disc Database (“CDDB”) identifier is derived from track duration information stored in the table of contents of a compact disk (“CD”); and the International Standard Recording Code (“ISRC”) uniquely identifies sound recordings and music video recordings, to name but a few such identifiers.

Such identifiers may be associated in databases to varying degrees with individual printings or production runs of a work or a manufactured item, with groups of printings or production runs, with a manufacturer, publisher, and/or distributor, and with additional information, such as, for example, contributors to a creative work, chapters, series, scores, distribution dates, and the like. Without being exhaustive, character strings comprising identifiers may be created and/or selected in the following ways: they may be arbitrarily selected from within a range or according to an algorithm, they may be issued in a chronological or other series, and/or they may encode or embody information, such as a date, track duration information from a table of contents, or similar.

Identifiers are often found in association with or provided along with instances of unknown works. When an identifier is not provided, and at least in the case of those identifiers which encode or embody information, it is sometimes possible to independently derive an identifier based on information found in and/or associated with an instance of an unknown work. The provided or independently derived identifier may be checked against a database of identifiers associated with known works, potentially allowing the new unknown work to be identified as an instance of an existing known work.

For example, in the case of the CDDB identifier, the CDDB identifier is the result of performing a calculation or algorithm on the track duration information stored in the table of contents of a CD. When presented with a new as-of-yet unknown CD, a computer driven media player may utilize an equivalent algorithm to derive the CDDB identifier for the CD, may then lookup known works with the same or an equivalent CDDB identifier, and may then obtain additional information regarding the CD, such as the original album cover, the table of contents, the artists or other contributors to the work, and the like. The media player may then utilize other identifiers which may be present on or which may be derived from the CD to associate the CD with the information so obtained, allowing the media player to “recognize” the disk in the future without having to re-perform the process of deriving the CDDB identifier and checking it against known works.

Particularly in the context of digital works, the diverse ways of producing, encoding, encrypting, transmitting, and reproducing a work may not employ and/or make difficult the use of such identifiers. Other sources of information may be tapped to identify an unknown work, such as a filename associated with a work.

Filenames may range from those which are arbitrarily or even randomly created or assigned to those which encode specific information, whether in a human readable form or much as certain of the identifiers discussed above encode specific information. Various methods have been developed to extract information from filenames. For example, U.S. Pat. No. 6,794,566, titled “Information Type Identification Method and Apparatus, E.G. For Music File Name Content Identification,” discloses a method to identify artists and titles based on the filenames of music files present on a computer, to check or obtain metadata which may be associated with the identified artists and titles, and to algorithmically develop and/or update playlists based on the artist, title, and metadata information. The filenames discussed in U.S. Pat. No. 6,794,566, however, must all be present on one computer and must conform to a common set of patterns, such as “artist+separator+title” or “title+separator+artist,” that artist names are less numerous than title names, that artist names are more redundant that title names, that artist names commonly contain fewer words than title names, and that in most cases artist names appear before title names in the filenames.

However, the art has not demonstrated a method or apparatus capable of analyzing filenames and file contents found “in the wild” on diverse network locations as well as other information to determine a correlation between an unknown file and a known broadcast television show or other known audiovisual work.

### SUMMARY

This summary is provided to introduce a selection of concepts in a simplified form that are further described below in the detailed description. This summary is not intended to identify key feature or essential features of the claimed subject matter, nor is it intended to be used to limit the scope of the claimed subject matter.

Generally stated, the disclosed invention is directed to a method and apparatus in which the filename for an unknown work, corresponding file contents, and information associated with the filename are analyzed and compared to information relating to one or more known works, which known works comprise at least broadcast television shows and other audio visual works. Information regarding the known works may be presented to at least one user, confirmation may be obtained, and alternative sources may be presented from which alternative sources the known works may be obtained.

### BRIEF DESCRIPTION OF THE DRAWINGS

FIG. 1 is an exemplary network and device diagram in and through which systems and methods consistent with the principals of the invention may be implemented.

FIG. 2 depicts a viewer in a mode wherein an audiovisual work may be played back.

FIG. 3 depicts a viewer in a mode in which an audiovisual work may be identified.

FIG. 4 depicts a functional block diagram of an exemplary computing device comprising a system server.

FIG. 5 is an operational flow diagram generally illustrating steps consistent with certain aspects of the invention.

FIG. 6 is an operational flow diagram generally illustrating steps consistent with certain aspects of the invention.

FIG. 7 is an operational flow diagram generally illustrating steps consistent with certain aspects of the invention.

FIG. 8 is an operational flow diagram generally illustrating steps consistent with certain aspects of the invention.

FIG. 9 depicts a functional block diagram of an exemplary computing device that may be used to implement one or more embodiments of components of the invention.

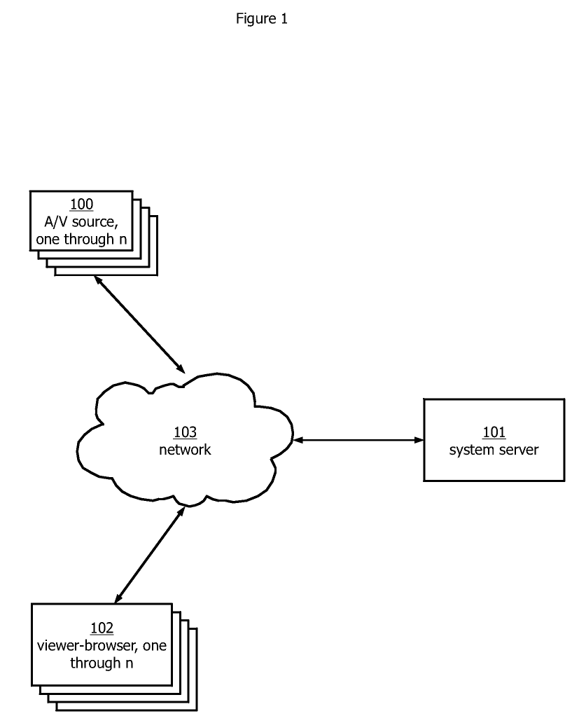

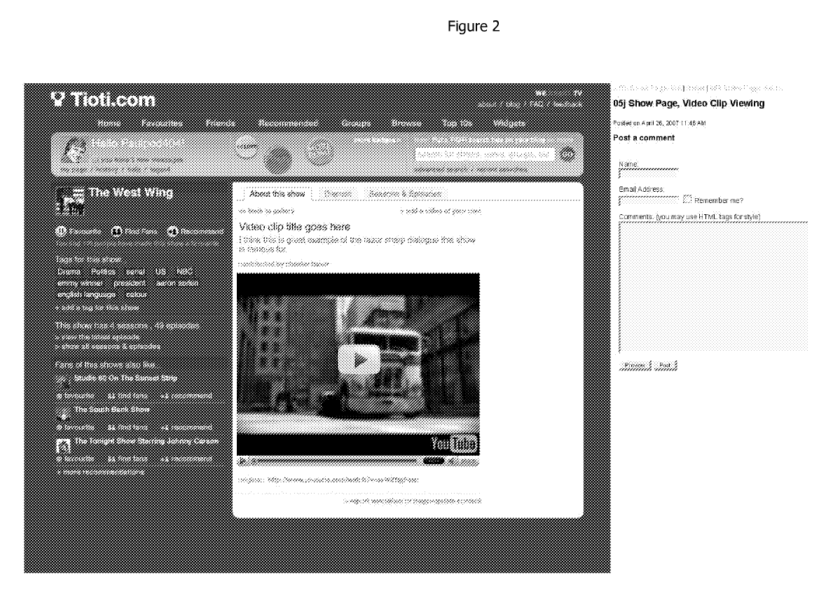

### DETAILED DESCRIPTION

The following detailed description refers to the accompanying drawings. The same reference numbers in different drawings identify the same or similar elements. The following detailed description is for the purpose of illustrating embodiments of the invention only, and other embodiments are possible without deviating from the spirit and scope of the invention, which is limited only by the appended claims. Certain of the figures are labeled with terms associated with specific software applications or categories of software applications, such as “browser,” “webserver,” or “db,” which is an abbreviation of “database.” The labels and the following discussion use these terms and related terms such as “website” as examples and not as limitations. Equivalent functions may be provided by other software applications operating on general and/or specialty purpose computing devices. Thus, references in this document to a browser, a webserver, or a database should be understood to describe any software application providing similar functions, operating on suitable hardware for such software application, and provided with suitable communication facilities. References to a “network” shall be understood to describe any suitable network capable of providing communication between the other components, such as but not limited to the Internet. The components depicted in the figures represent function groups; it should be understood that such function groupings need not exist as discrete hardware devices or software applications and that the functions described as occurring within, comprising, or being provided by a grouping may be provided within or by common or separate physical and/or logical hardware devices and software applications. The components within and comprising any of the function groupings may be regrouped in other combinations and certain of the functions may be omitted without deviating from the spirit of the disclosed invention.

Referring now to the figures, this document discloses a method, system, and apparatus in which viewers utilize a browser and/or other client software 102 to download and/or to otherwise access (referred to herein as a “download”) audiovisual works over or across a network 103, such as the Internet. Figure two depicts an example of a viewer 102 in a mode wherein an audiovisual work has been downloaded and which may be played back.

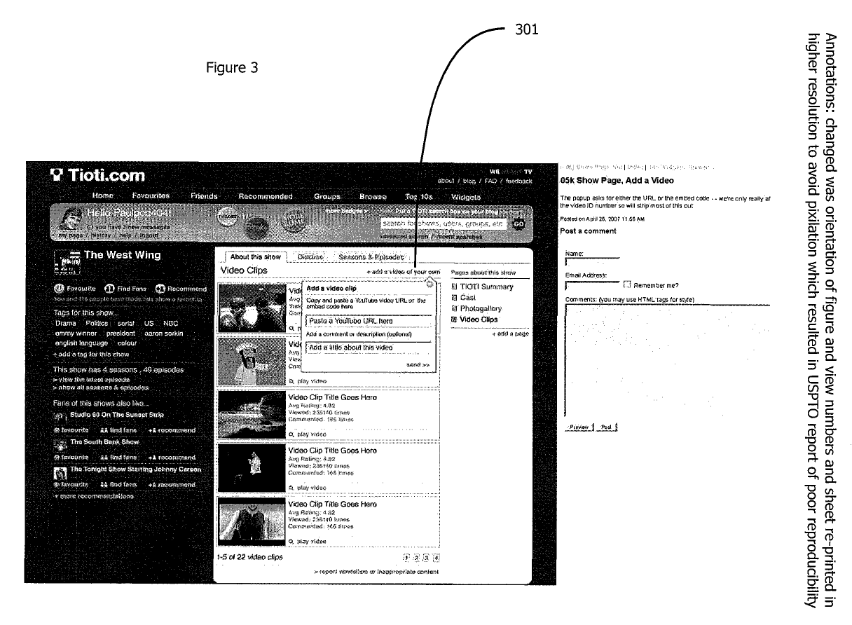

Prior to and/or contemporaneous with downloading an audiovisual work, a party utilizing the viewer 102 at least identifies files to be downloaded. Figure three depicts an example of a viewer 102 in a mode wherein an audiovisual work may be identified to be downloaded. Audiovisual works may be identified by, for example, copying-and-pasting, clicking on, selecting, speaking (to an interactive voice response system) typing in or otherwise making use of a uniform resource identifier (“URI”, as shown in drawing FIG. 301. The example provided in FIG. 3 and this discussion should be understood to be non-limiting. Identification of files may be through many other means, such as by providing software instructions that, when implemented, provide that when a viewer right-clicks or takes another action with respect to a URI on a website or similar, that the viewer may select an option to download the identified file to and/or through the viewer 102 or to otherwise provide the URI to the viewer 102, which viewer 102 will note the URI selected and/or identified by the viewer. In other embodiments, a viewer 102 may be utilizing and/or receive information from other hardware devices and software applications, such as an over-the-air and/or cable digital tuner (which may also include recording media for the temporary storage of audiovisual works), which information may identify audiovisual file(s) selected by and/or otherwise available to the viewer 102, such as available through a broadcast medium.

The identified audiovisual file(s) may be made available by one or more audiovisual sources 100. The audiovisual sources 100 may comprise one or more servers and/or may comprise clients in a peer-to-peer network, such as a Bitorrent network (in which case the viewer 102 is likely to also be a client in the peer-to-peer network), and/or the audiovisual sources may comprise terrestrial, satellite, and/or cable broadcasts.

Among other information, the URI may be passed to the system server 101 by the viewer 102. Alternatively, the system server 101 may access the audiovisual files and provide an interface which allows the viewer 102 to view and interact remotely with the media, in which case the URI file request and access to the file may be by and through the system server 101, rather than by and through the viewer 102. Alternatively, all or part of the system server 101 may comprise application software which resides on and is executed by the viewer 102, which system server 101 application software may be updated from time to time by a remote system server 101.

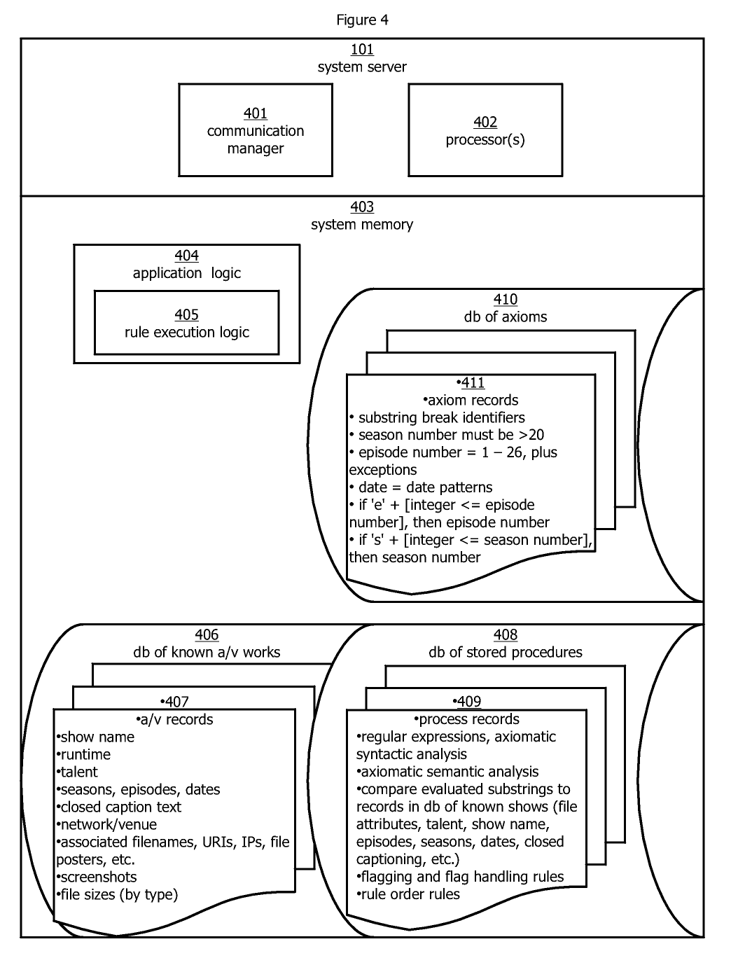

A schematic depiction of functional components which may comprise the system server 101 is provided in FIG. 4. The system server 101 may comprise a communication manager 401, one or more computer processors 402, and a system memory 403. The system memory 403 may be provided by, for example, volatile and nonvolatile memory, removable storage, and the like as are known in the art.

The system memory 403 may contain entries which comprise application logic 404, a database of known audiovisual works 406, a database of stored procedures 408, and a database of axioms 410. The databases may be provided separately from one another or together in one database. The databases may follow flat, hierarchical, relational, object, and/or post-relational database models, as are well known in the art. The database files may be unordered, ordered, and/or structured. Structured database files may include heaps, hash buckets, B+ trees, and indexed sequential access model (“ISAM”) files. For example, temporary and/or working database files may be unordered while more stable files which have existed for a longer period of time—such as audiovisual records 407 and/or the axiom records 411—may be processed into a structured form, such as an ISAM file. One or more of the database(s) and/or columns of entries therein may be indexed to speed query execution.

The application logic 404 may further comprise rule execution logic 405. The system memory 203 and/or application logic 404 may further comprise instructions for applications such as an operating system, a webserver, communication programs and other support programs as are well known in the art (not shown).

The database of known audiovisual works 406 may further comprise audiovisual records 407; the database of stored procedures 408 may further comprise process records 409. The audiovisual records 407 are depicted as comprising entries, which (in general throughout this disclosure) may be columns in a relational database, such as, for example and without limitation, the names of audiovisual works (also referred to as “shows”, the runtime of the work, the talent which appears in and/or contributed to the work (the talent comprising actors, producers, directors, writers, makeup artists, set designers, costumers, and similar), season and episode information, dates the audiovisual work aired, the closed captioning text and/or an index of such text which may have been associated with the audiovisual work in the past, the network or other venue which first carried, broadcast, or distributed the audiovisual work, and the filenames, URIs, Internet Protocol (“IP”) addresses, parties known to have posted the work on a network in the past, and the like which have been associated with the work in the past.

The database of stored procedures 408 defines stored procedures, processes and/or methods referenced by the application logic 404 and/or the rule execution logic 405. The database of stored procedures 408 may further reference the database of axioms 410 and axiom records 411 to obtain rules expressing formal assumptions about the semantic and syntactic content of URIs (discussed further below). The process records 409 are depicted as comprising entries which define, for example, regular expressions. The regular expressions may, for example, define string parsing logic or equivalent which, when loaded into the application logic 404 and rule execution logic 405 and executed by the processor(s) 402, may divide URIs into substrings based on syntactic assumptions about the URIs and which return such substrings for further processing. The regular expressions may access the axiom records 411 to obtain definitions and processes, such as, for example, to obtain the then-current definition of substring breaks (characters which define a break or potential break point between different substrings within a URI). The process rule records 409 are further depicted as comprising entries which, when loaded into the application logic 404 and rule execution logic 405 and executed by the processor(s) 402, analyze the semantic content of URI substrings according to the axiom records 411 (discussed further below) and which label corresponding substrings, such as for example, as a season number or as a name. The process rule records 409 are further depicted as comprising entries which may compare evaluated and labeled substrings to entries in the audiovisual records 407. The process rule records 409 are further depicted as comprising entries which may flag certain events, such as a match or mismatch between different labeled substrings or between labeled substrings and records regarding known audiovisual works 407, and which may implement certain other steps as a result of a flag handing rules.

The database of axioms 410 may comprise axiom records 411. The axiom records 411 may comprise entries containing rules which embody formal assumptions about the semantic and syntactic content of URIs. The line between syntax and semantics is not amendable to close definition, the terms being used as convenient shorthand. Without limitation, a syntactic assumption may be generally defined as an assumption based on the order and identity of characters within a URI and the location of breaks between different substrings within a URI. As a non-limiting example of syntactic assumptions, substring break identifiers such as “\ . -” and similar may be used by regular expressions to label break points between different substrings within a URI and which may be used to identify machine-readable and machine-relevant features of a URI, such as a domain name within a URI and/or the concluding substring of a URI which typically identifies a file type. Without limitation, a semantic assumption may be generally defined as an assumption based on the meaning of substrings within a URI. As a non-limiting example of semantic assumptions, integer substrings between 1 and 20 may be labeled as season number, because, for example, it may be found that no audiovisual works have greater than 20 seasons; if such an integer is preceded by the letter ‘s,’ then another semantic axiom might label the integer as a high confidence season number because the ‘s’ is often a shorthand for “season;” integer substrings between 1 and 26, plus a list of exceptions may be labeled as episode numbers, because it may be found that most audiovisual works have 26 or fewer episodes; if such an integer is preceded by the letter ‘e,’ then another semantic axiom might label the integer as a high confidence episode number because the ‘e’ is often a shorthand for “episode.” The same substring might receive more than one label. The blurry line between syntactic and semantic assumptions may be illustrated by an axiomatic rule such as one which, when two adjacent integer substrings occur, both of which may be labeled as seasons or episodes, and neither of which is preceded by a character such as ‘e,’ then the first such integer will be labeled as the likely season number, because season numbers more often precede episode numbers than visa versa. Other syntactic and/or semantic axiomatic rules may, for example, determine if a set of adjacent substrings conform to known date patterns, such as mmddyyyy, ddmmyyyy, [month-text] ddyyyy, and the like.

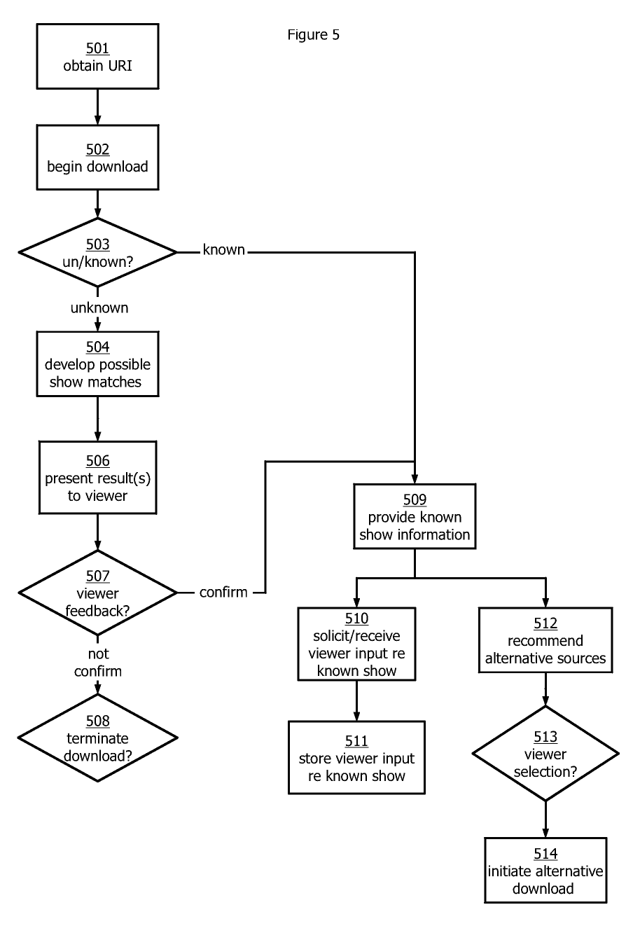

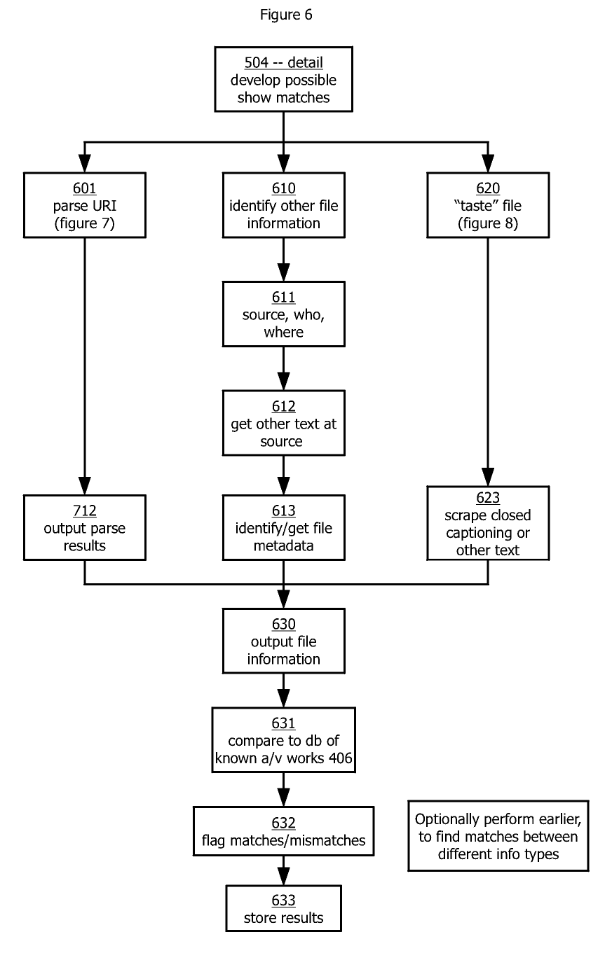

FIG. 5 depicts an example of an application logic 404 process. The example begins with the system server 101 obtaining a URI. The URI may be obtained from a viewer 102 which may transmit the URI to the system server 101. As noted above, the system server may provide some or all of the viewer 102 functions remotely, in which case the transmission of the URI to the system server 101 may be a local transmission. The viewer 102 may begin to download an audiovisual work from an audiovisual source 100. Download of the audiovisual work may take place before the system server 101 obtains the URI 501. The URI may be tested to determine if the URI and/or the filename component of the URI is known or unknown 503. If unknown, possible matches between the unknown file and known audiovisual works may then be developed 504. Steps of an exemplary process which may perform such a matching operation are depicted in FIGS. 6, 7, and 8 and are described further below.

The resulting matches, if any, may be presented 506 to and/or through the viewer 102. The viewer 102 may receive viewer feedback 507. The viewer feedback 507 is depicted as a choice between a confirmation and a non-confirmation of one or more of the potential matches presented at 506; though it should be understood that the viewer feedback may further and/or alternatively comprise text typed into an interface by a viewer, including text typed into an interface which provides predictive assistance, which text may describe the audiovisual work. Depending on the viewer feedback received at 507, additional logic may be executed. For example, at step 508, a decision may be made whether or not to terminate an ongoing download if the viewer is not able to confirm a match with a known audiovisual work and/or if a confirmation is made with an audiovisual work and/or an instance thereof which is known to be unlawful.

Step 509 depicts the system server 101 providing information to the viewer 102 regarding the known audiovisual work. Such information may be obtained, for example and without limitation, from the database of known audiovisual works 406, such as the entries for sample screenshots, information regarding the talent which contributed to the audiovisual work, the seasons, episodes, and other of the information which may be contained in the database of known audiovisual works 406. Step 510 depicts soliciting and/or receiving input from the viewer 102 regarding the information provided regarding the known audiovisual work. Such input may comprise, for example, that certain of the information is incorrect, correct, or may be supplemented where missing. Step 511 depicts storing such viewer input, such as in the database of known audiovisual works 406.

Step 512 depicts recommending an alternative audiovisual source 100 from which the viewer 102 may obtain the known audiovisual work. Such alternatives may be selected from, and may identify for the viewer, for example, audiovisual sources 100 which are known to provide audiovisual works which are properly licensed and/or which are provided on more favorable or otherwise different licensing terms and/or which have a faster download rate and/or which have a higher or lower resolution and/or encoding rate and/or which are provided in a different file format and/or which have a different price and/or which are associated with a service provider with whom the viewer 102 may already have a relationship. Step 513 depicts determining if a viewer selection has been received regarding an alternative source. Step 514 depicts implementing a viewer selection by terminating the original download and initiating download of the viewer's selection of an alternative source.

FIG. 6 depicts a detail of step 504 from FIG. 5, the step during which possible matches are developed between an unknown audiovisual work and known audiovisual works. In no particular order, the 504 detail depicts developing information regarding the unknown audiovisual work from at least three sources, the content of URI (generally beginning with step 601), information related to the URI (generally beginning with step 610), and information developed from “tasting” the file obtained at or through the URI (generally beginning with step 620).

Step 601 depicts parsing the identified URI into substrings. Parsing a URI into substrings 601/700 may be accomplished by a variety of well known methods, such as use of regular expressions and programming languages such as Perl and/or text editors, such as Ed (a Unix text editor), and/or command line utilities, such as Grep (originally written for the Unix operating system), and/or through classes provided in programming languages and frameworks, such as the UriParser Class provided as part of Microsoft Corporation's .NET Framework. Examples of regular expressions which may be used to perform a partial parse of a URI are as follows:

(.+?) (\\[)?(\\d{1,2})x(\\d{1,2})(,(\\d{1,2}))?(\\])?.*

(.+?[̂\\p{Alpha}])(s(e(ason)?)?|temp(orada)?)[̂\\p{Alnum}]*([0-9]+)[̂\\p{Alnum}]*[−&][̂\\p{Alnum}]*(s(e(ason)?)?|temp(orada)?)?[̂\\p{Alnum}]*([0-9]+)

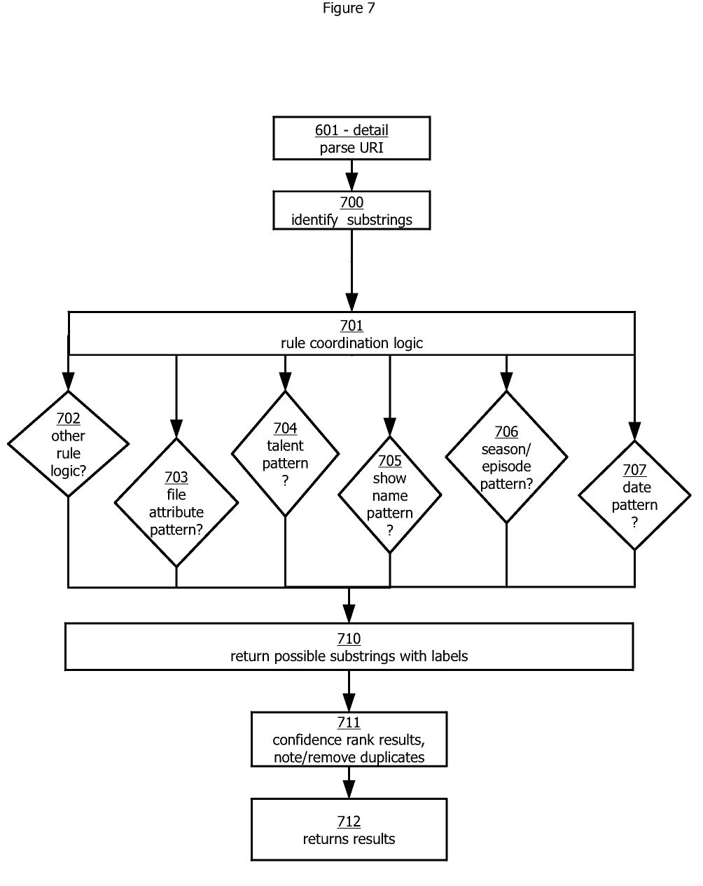

Regular expressions or equivalent (referred to herein simply as “regular expressions”) are formal logical rules for parsing a string into one or more substrings. In this disclosure, the regular expressions embody logical rules and definitions, such as may be found in the axioms described in the database of axioms 410 and the axiom records 411 (described above). Referring to FIG. 7, the regular expressions may be used to identify one or more substrings within a URI 700, and to label those substrings which meet certain criteria (discussed further below in relation to FIG. 7), steps 701 through 710. For example, if a URI is <http://www.secondlevel.firstleveldomainname/?query/sopranos.S06E20.HDTV.XviD-LOL>, regular expressions may be used to identify the URI scheme <http>, the first-, second- and other higher-level domain names which form part of the path name, such as <www.secondlevel.firstleveldomainname>, the query component <?query>, and the resource name, in this case, <sopranos.S06E20.HDTV.XviD-LOL>. Regular expressions may further be used to parse the resource name and other substrings into further substrings. For example, the resource name may be parsed into substrings <sopranos> <S06> <E20> <06> <20> <S06E20> <HDTV> <XviD> <LOL> and <EviD-LOL>, represented by step 700 in FIG. 7. These substrings may further be labeled according to logic and procedures contained in the axiom records 411. For example, FIG. 7 depicts decisions junctions 702 through 707 as examples which represent substring labeling logic as decision junctions. Only the affirmative output from the decision junctions is depicted, it being assumed that the consequence of not finding a particular pattern in a substring is not labelling the substring with a corresponding label.

FIG. 703 is a decision regarding whether a substring contains a file attribute pattern. The code representing this decision may simply match a substring to database entries for strings associated with what have been previously identified as file attributes. For example, in the preceding example,

<HDTV> and/or <XviD> may be entries in such such a database as they are, respectively, associated with audiovisual files encoding high-definition television and/or using the XviD video codec following the MPEG-4 standard.

FIG. 704 depicts an example decision regarding whether a substring matches a pattern for what may be a recitation of the talent which may have contributed to an audiovisual work, such as if a substring begins with characters “dir” and if, for example, the substring is not the first substring in a resource name.

FIG. 705 depicts an example decision regarding whether a substring matches a pattern for what may be the name of an audiovisual work, such as, for example, if the substring is found at the beginning of the resource name and that the substring does not match another pattern, such as a season or episode number pattern or a file attribute pattern. In the preceding example, <sopranos> may be the only substring which meets these criteria.

FIG. 706 depicts an example decision regarding whether a substring matches a pattern for what may be a season or episode number. As indicated previously, this may include one or two digit integers with a value less than 20, for a season number, or less than 26 for an episode number and which may be preceded by a letter, such as “s” for season or “e” for episode. In the preceding example, <S06> and/or <06> may meet the criteria for a season number while <E20> and/or <20> meets the criteria for an episode number.

FIG. 707 depicts an example decision regarding whether a substring matches a pattern for known date patterns, such as a first character string which starts with <Jan> <Feb> <Mar> <Apr> <May> <Jun> <Jul> <Aug> <Sept> <Oct> <Nov> or <Dec> and/or equivalent numerical values for months and which is followed by a one or two digit integer number less than 31, and which is followed by a two or four digit integer number which is less than or equal to the final two or four digits of the integer number which is the current year. As noted above, the date patterns may be stored in the axiom records 411. In the preceding example, no substrings and/or combinations of substrings may match known date patterns.

FIG. 7 is not intended to be exhaustive, so FIG. 702 indicates other logical pattern detection steps, such as, for example, that a substring in the final position within a resource name may be labeled as the creator of the file provided it has fewer than four characters and/or if it matches a list of known substrings associated with creators of such files. For example, in the example above, <LOL> may be labeled as the creator of the file because it occurs in the final position and because it matches a known creator of such files.

FIG. 701 depicts rule coordination logic to control the order of execution of and any iteration of the pattern decisions 702 through 707, for example, if substrings matching the season number are to be labeled before the logic to identify episode numbers is applied. Also depicted in FIG. 7 is 710, which describes the point (or points) during the process at which all possible substrings and labels are returned. As an optional step, a confidence rank may be assigned to the attachment of a label to a substring. This may occur, for example, if it is known that ninety-five percent of instances of a given substring have been confirmed to have been associated with a certain file attribute, then the substring <XviD> may be labeled as a file attribute with a ninety-five percent confidence or, for example, if a substring matches one or more of a multi-criteria decision junction. Duplicate substrings and labels may be removed and/or may be noted as existing in duplicate (and how many duplicates).

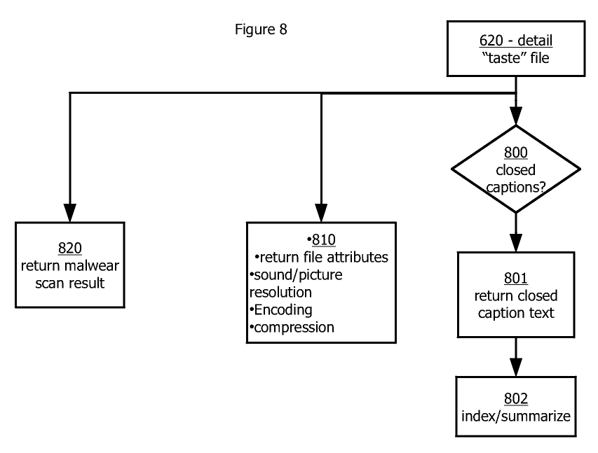

Turning then to FIG. 8, which provides a detailed view of the “taste” file step 620. In no particular, order, the viewer's client audiovisual application may compile and return information regarding the outcome, if any, of a malwear scan 820 on the file referenced by the URI, on the file attributes 810, and on the presence 800 and content of closed captioning text 801. The file attributes are depicted in FIG. 810 as comprising the sound and/or picture resolution, the file type, the encoding, decoding, and compression (if distinct) algorithms used to encode, decode, and/or compress the file. This information from “tasting” the file may be returned, and indexed and/or algorithmically summarized, as may be the case for example, with the closed captioning text 802, which might otherwise comprise a large amount of data.

Returning, to FIG. 6, the output from the preceding three processes, 601 through 623, may be returned, either separately or together. The output may be returned as the processes proceed, rather than at a particular conclusion. The output from one of these processes may be an argument in a process, such as that a substring may qualify for a particular label only if one or another of the other labels are not applied to the substring. The substrings, both in raw form and as they may be labeled, may be compared to records 407 in the database of known audiovisual works 406. To conserve computational resources and/or to increase the reliability of results, substrings which have been labeled with a particular label, such as a date or as a season, may be compared only to entries within the records 407 which are associated with such label(s). To further conserve computational resources and/or to improve the relevance of the results, the comparison of the output from step 630 may proceed according to a logical procession. For example, if an unknown file returns substrings labeled as “season,” “episode” and “show name,” then the application logic 404 may first identify matching results among the records 407 and/or indexes of the same for known audiovisual works which match the substring labeled “show name;” the substrings labeled “season” and “episode” may then be compared to corresponding entries or indexes in the records 407 which first matched the “show name.” Alternatively, all substrings and all labeled substrings may be matched against all records 407 in the database and/or a global index of known audiovisual works 406. Alternatively, substrings may be rejected as candidates to be individually searched against all records 407 in the database of known audiovisual works 406 if it is determined that the substrings individually return too many results. Alternatively, combinations of substrings may be utilized to produce a manageable number of results. For example, the substrings <sopranos>, <S06E20> and <XviD> may individually produce thousands of potential matches, while together <sopranos> and <S06E20> produce twenty results while <sopranos>, <S06E20> and <XviD> produce four results among known audiovisual works.

FIG. 632 depicts flagging matches and mismatches between various of the file information sources. For example, a URI may include a substring which matches a file attribute such as <DivX>, but the corresponding information from the file “tasting” operation 620 may indicate a different file type, such as <XviD>. This match or mismatch may be flagged and may comprise information which is presented to the viewer and/or which forms an argument for other of the application logic 404.

Computing device 900 includes one or more communication connections 908 that allow computing device 900 to communicate with one or more computers and/or applications 909. Device 900 may also have input device(s) 907 such as a keyboard, mouse, digitizer or other touch-input device, voice input device, etc. Output device(s) 906 such as a monitor, speakers, printer, PDA, mobile phone, and other types of digital display devices may also be included.

1: A system to compare at least one unknown audiovisual work to known audiovisual works, which system is comprised of the following components:
a communication manager;
at least one computer processor;
a first system memory comprising database entries associated with known audiovisual works; and
a second system memory further comprising instructions which, when executed:
receive at least one URI, which at least one URI references at least one file, which at least one file contains the at least one unknown audiovisual work;
parse some or all of the at least one URI into at least one substring;
compare at least one of the at least one substring to entries associated with known audiovisual works in the database;
obtain at least one result from the comparison;
transmit the at least one result to at least one party.

2: The system according to claim 1 where the second system memory further comprises instructions which, when executed, receive information from the at least one party regarding whether the at least one result is and/or is not a match with the unknown audiovisual work.

3: The system according to claim 2 further comprising instructions which, when executed, store the received information in a record in a database which record is associated with the at least one URI and/or the at least one substring and/or the at least one result.

4: The system according to claim 1 where the second system memory which further comprises instructions which, when executed, parse some or all of the at least one URI into at least one substring, further comprises instructions which, when executed, parse some or all of the at least one URI into at least one substring based on axioms comprising substring break identifiers which, if identified in a URI, label a break between substrings within the URI.

5: The system according to claim 1 where the second system memory further comprises instructions which, when executed, label at least one of the at least one substring according to rules which implement axioms, which axioms are related to the syntactic and semantic content of URIs.

6: The system according to claim 5 where the axioms are selected from a group comprising:
if a substring is found which contains an integer less than 20, then it may be labeled as a season number,
if a substring is found which contains an integer less than 20 and which substring starts with the character ‘s,’ then such substring may be labeled as a season number,
other than exceptions, if a substring is found which contains an integer less than 26, then such substring be labeled as an episode number,
other than exceptions, if a substring is found which contains an integer less than 26, and if the integer is preceded by the character ‘e,’ then it may be labeled as an episode number,
if a substring is found which qualifies as a season number and if the next substring when read from left to right qualifies as an episode number, then label the two substrings as season and episode numbers,
if adjacent substrings are found which conform to known date patterns, then such adjacent substrings may be labeled as dates.

7: The system according to claim 5 further comprising substring labels which are associated with the entries associated with known audiovisual works and where the comparison of the at least one of the at least one substring to entries associated with known audiovisual works in the database is limited to comparing substrings labeled with a label, which label is associated with such entries.

8: The system according to claim 1 where the second system memory further comprises instructions which, when executed, transmit to the at least one party a different URI with which the at least one party may obtain an audiovisual work associated with the at least one result.

9: A method in a computer system for identifying at least one unknown audiovisual work comprising the following steps, not necessarily in the following order:
a) receiving at least one URI which references at least one file, which at least one file contains the at least one unknown audiovisual work;
b) parsing the at least one URI into at least one substring;
c) labeling at least one of the at least one substring according to rules derived from axioms, which axioms are related to the syntactic and semantic content of URIs;
d) obtaining technical information regarding the at least one file referenced by the at least one URI, where the technical information is selected from a group comprising:
file type, file size, encoding and/or compression algorithm(s) employed in coding and/or decoding the file, compression ratio, and/or sample rate of either or both of the audio or visual components of the unknown audiovisual work, and/or the closed captioning text contained in and/or associated with the file;
e) obtaining external but related information regarding the file referenced by the at least one URI, where the external but related information is selected from a group comprising:
the IP address to which the at least one URI resolves;
text associated with the at least one URI, where such text is one or more information types selected from a group comprising:
the display text associated with the at least one URI,
text found on a source page referenced by and/or associated with the at least one URI,
text found in a domain name contained in the at least one URI,
text found in a WHOIS record associated with a domain name contained in the at least one URI,
f) comparing the URI and/or the at least one substring and/or the at least one labeled substring and/or the technical information and/or the external but related information to at least one of the following:
records in a database comprising information regarding known audiovisual works,
records in a database comprising information regarding file types,
and obtaining at least one matching result between the unknown audiovisual work and at least one known audiovisual work;
g) presenting at least one result from the comparison to at least one party.

10: The method according to claim 9 further comprising providing at least the one party with an alternative source from which the known audiovisual work may be obtained.

11: The method according to claim 9 where the axioms are selected from a group comprising:
substring break identifiers which, if identified in a URI, may label a break between substrings within the URI,
if a substring is found which contains an integer less than 20, then it may be labeled as a season number,
if a substring is found which contains an integer less than 20 and which substring starts with the character ‘s,’ then such substring may be labeled as a season number,
other than exceptions, if a substring is found which contains an integer less than 26, then such substring be labeled as an episode number,
other than exceptions, if a substring is found which contains an integer less than 26, and if the integer is preceded by the character ‘e,’ then it may be labeled as an episode number,
if a substring is found which qualifies as a season number and if the next substring when read from left to right qualifies as an episode number, then label the two substrings as season and episode numbers,
if adjacent substrings are found which conform to known date patterns, then such adjacent substrings may be labeled as dates.

12: The method according to claim 9 further comprising providing at least the one party with additional information regarding a known audiovisual work, which known audiovisual work is an at least one result from the comparison, and where such additional information comprises one or more selections from a group comprising:
the title or other name or identifier given to the audiovisual work;
the runtime of the audiovisual work;
the talent which contributed to the audiovisual work;
the season, episode, and date information associated with the audiovisual work;
the closed caption text associated with the audiovisual work;
the network and/or other venue on which the audiovisual work appears and/or appeared;
URIs associated with the audiovisual work;
IP addresses associated with the audiovisual work;
screenshots and/or sound samples from the audiovisual work;
the resolutions in which the audiovisual work is available;
the file size and/or file type in which the audiovisual work is available;
the price for which the audiovisual work may be available;
the advertisements which may be found in and/or associated with the audiovisual work.

13: The method according to claim 9 further comprising flagging matches and/or mismatches between labeled substrings and the technical information.

14: The method according to claim 9 where presenting at least one result from the comparison to at least one party further comprises requesting whether the at least one result is and/or is not a match with the unknown audiovisual work.

15: The method according to claim 14 further comprising storing at least one response to the request in a record in a database which record is associated with the at least one URI and/or the at least one substring and/or the at least one result.

16: The method according to claim 15 further comprising determining if the at least one URI has been received previously and whether the at least one URI has been previously associated with a known audiovisual works.

17: The method according to claim 9 where comparing the URI and/or the at least one substring and/or the at least one labeled substring and/or the technical information and/or the external but related information to the listed databases includes indexing the databases and/or the URI and/or the at least one substring and/or the at least one labeled substring and/or the technical information and/or the external but related information and using the index in the comparison process.

18: A computer-readable medium containing instructions for controlling a computer system to identify an unknown audiovisual work by a method comprising the method of claim 9.

19: A method in a computer system for identifying at least one unknown audiovisual work comprising the following steps, not necessarily in the following order:
transmitting a URI to a system server, which URI references at least one unknown audiovisual work;
receiving from the system server at least one potential matches between the at least one unknown audiovisual work and at least one known audiovisual work;
displaying the at least one potential match to at least one viewer;
receiving confirmation from the at least one viewer regarding whether the at least one potential match among the known audiovisual works is and/or is not a match with the unknown audiovisual work;
receiving from the system server at least one alternative source from which the known audiovisual work may be obtained.

20: A computer-readable medium containing instructions for controlling a computer system to identify an unknown audiovisual work by a method comprising the steps of claim 19.
